(19) United States
(12) Patent Application Publication
(10) Pub. No.: US 2026/0116043 A1
(43) Pub. Date: Apr. 30, 2026

(54) THERMOPLASTIC RESIN SHEET, METHOD FOR MANUFACTURING THERMOPLASTIC RESIN SHEET, AND METHOD FOR MANUFACTURING BATTERY EQUIPPED WITH THERMOPLASTIC RESIN SHEET

(71) Applicant: NOK CORPORATION, Tokyo (JP)

(72) Inventors: Akira FUNAHASHI, Fujisawa-shi (JP); Takayuki OYAMA, Fujisawa-shi (JP)

(21) Appl. No.: 19/368,177

(22) Filed: Oct. 24, 2025

(30) Foreign Application Priority Data
Oct. 25, 2024 (JP) 2024-188568

(51) Int. Cl. B32B 7/027; B32B 27/08; B32B 27/32; B32B 27/36

(52) U.S. Cl. CPC B32B 7/027; B32B 27/08; B32B 27/32; B32B 27/36; B32B 2260/021; B32B 2260/046; B32B 2307/30

(57) ABSTRACT

A thermoplastic resin sheet is a sheet of thermoplastic resin and includes a core material of sheet shape having a lower thermal expansion coefficient than the thermoplastic resin.

### BACKGROUND

### 1. Technical Field

The present disclosure relates to a thermoplastic resin sheet, a method for manufacturing a thermoplastic resin sheet, and a method for manufacturing a battery equipped with a thermoplastic resin sheet.

### 2. Description of the Related Art

There are thermoplastic resin sheets known to function as adhesive sheets that join two members at a certain interval. For example, International Publication No. 2015/198737 proposes a thermoplastic resin sheet that has, on a surface thereof, a functional group introduced by surface treatment and that has excellent initial adhesiveness and electrolyte-resistant adhesiveness. Also, there are thermoplastic resin sheets known to function as sealing sheets that seal between two members.

When a thermoplastic resin sheet is mounted between two members, the thermoplastic resin sheet is heated to melt the thermoplastic resin. However, when the linear thermal expansion coefficients of the two members are low, the thermoplastic resin sheet may be distorted due to the difference in linear thermal expansion coefficient between the thermoplastic resin and the two members.

### SUMMARY

The present disclosure has been made in view of such an issue, and an illustrative purpose of one embodiment thereof is to provide a technology for suppressing distortion of a thermoplastic resin sheet.

In response to the above issue, a thermoplastic resin sheet according to one embodiment of the present disclosure is a sheet of thermoplastic resin that includes a core material of sheet shape that has a lower thermal expansion coefficient than the thermoplastic resin.

Another embodiment of the present disclosure is a method for manufacturing a thermoplastic resin sheet. This method is a method for manufacturing the thermoplastic resin sheet according to any of the above and includes sandwiching the core material between sheets of the thermoplastic resin.

Yet another embodiment of the present disclosure is also a method for manufacturing a thermoplastic resin sheet. This method is a method for manufacturing the thermoplastic resin sheet according to any of the above and includes impregnating the core material with the thermoplastic resin.

Still yet another embodiment of the present disclosure is a method for manufacturing a battery. This method includes preparing components including a current collector and the thermoplastic resin sheet according to any of the above, and assembling components thus prepared. The assembling includes heating the thermoplastic resin sheet in a state of being sandwiched between current collectors.

It is to be noted that any arbitrary combination or rearrangement of the above-described structural components and so forth is effective as and encompassed by the present embodiments. Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a sectional view of a thermoplastic resin sheet according to an embodiment;

FIG. 2 is a process drawing that shows a manufacturing process of the thermoplastic resin sheet shown in FIG. 1;

FIG. 3 shows a battery that includes the thermoplastic resin sheet shown in FIG. 1;

FIGS. 4A and 4B show a battery that includes a thermoplastic resin sheet according to a comparative example;

FIG. 5 is a process drawing that shows a manufacturing process of the battery shown in FIG. 3;

FIG. 6 is a sectional view of a thermoplastic resin sheet according to a modification; and

FIG. 7 is a sectional view of one of a number of fibers in the case where a core material of a thermoplastic resin sheet according to a modification is a fiber structure.

### DETAILED DESCRIPTION

Before specific description of an embodiment is given, an overview of the embodiment will be described. The present embodiment relates to a thermoplastic resin sheet. The thermoplastic resin sheet functions as an adhesive sheet that joins two members at a certain interval. In this case, in the thermoplastic resin sheet, the thermoplastic resin is melted to penetrate into fine irregularities on the surfaces of the two members and then hardens in this state. Accordingly, the two members and the thermoplastic resin sheet are joined, or in other words, the two members are joined to each other via the thermoplastic resin. The thermoplastic resin sheet also functions as a sealing sheet that seals between two members. In this case, in the thermoplastic resin sheet, the thermoplastic resin is melted to penetrate into fine irregularities on the surfaces of the two members, providing sufficient sealing performance.

In any case, when a thermoplastic resin sheet is mounted between two members, the thermoplastic resin sheet is heated to melt the thermoplastic resin. However, when the linear thermal expansion coefficients of the two members are low, such as in the case of metal, for example, the thermoplastic resin sheet may be distorted due to the difference in linear thermal expansion coefficient between the thermoplastic resin and the two members. In contrast, in the present embodiment, the thermoplastic resin sheet includes a core material that has a lower linear thermal expansion coefficient than the thermoplastic resin. Accordingly, the linear thermal expansion coefficient of the thermoplastic resin sheet as a whole becomes lower, and hence, the difference in linear thermal expansion coefficient between the thermoplastic resin sheet and the two members becomes smaller. Therefore, the distortion of the thermoplastic resin sheet can be suppressed.

In the following, a preferred embodiment will be described with reference to the drawings. The embodiment is intended to be illustrative only and not to limit the disclosure, so that it should be understood that not all of the features or combinations thereof described in the embodiment are necessarily essential to the disclosure. Like reference characters denote like or corresponding constituting elements, members, and processes in each drawing, and repetitive description will be omitted as appropriate.

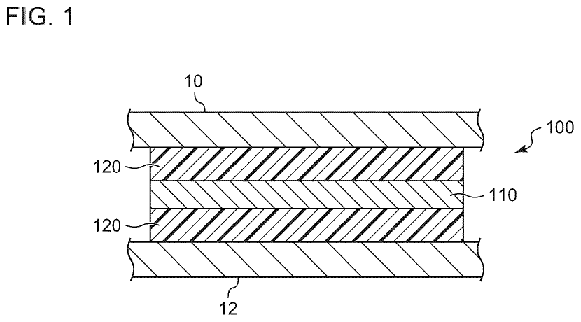

FIG. 1 is a sectional view of a thermoplastic resin sheet 100 according to an embodiment. In FIG. 1, the thermoplastic resin sheet 100 is mounted between a first member 10 and a second member 12. The thermoplastic resin sheet 100 functions as an adhesive sheet that joins the first member 10 and the second member 12 at a certain interval, as a sealing sheet that seals between the first member 10 and the second member 12, or as both.

The thermoplastic resin sheet 100 includes a core material 110 of sheet shape, and two thermoplastic resin layers 120, which are layers of thermoplastic resin. The core material 110 is sandwiched between the two thermoplastic resin layers 120. Thus, the thermoplastic resin sheet 100 is a sheet of thermoplastic resin that includes the core material 110 of sheet shape.

The relationship in thickness between the core material 110 and the two thermoplastic resin layers 120 is not particularly specified. The core material 110 may be thicker than a thermoplastic resin layer 120, or the core material 110 may be thinner than a thermoplastic resin layer 120. The thicknesses of the two thermoplastic resin layers 120 are typically the same but may differ from each other.

The thermoplastic resin layers 120 may have a low linear thermal expansion coefficient, more specifically, a linear thermal expansion coefficient of 5.0×10⁻⁴ or less. In this case, even when the members 10 and 12 are metal (e.g., aluminum, stainless steel, copper, nickel, and the like), i.e., even when the members 10 and 12 have low linear thermal expansion coefficients, the difference in linear thermal expansion coefficient between the thermoplastic resin layers 120 and the members 10 and 12 is small. Therefore, the distortion of the thermoplastic resin layers 120 and thus the thermoplastic resin sheet 100 can be suppressed.

The thermoplastic resin layers 120 preferably have electrolyte resistance. The “electrolyte resistance” as used herein means resistance to electrolytes and the property of not causing a chemical reaction when in contact with an electrolyte and hence not deteriorating when in contact with an electrolyte. When the thermoplastic resin layers 120 have the electrolyte resistance, the thermoplastic resin sheet 100 can be used in an environment where it comes into contact with an electrolyte.

The thermoplastic resin layers 120 preferably have excellent electrolyte-resistant adhesiveness. The “electrolyte-resistant adhesiveness” as used herein means the property of maintaining adhesiveness even when in contact with an electrolyte. When the thermoplastic resin layers 120 have excellent electrolyte-resistant adhesiveness, the thermoplastic resin sheet 100 can be used as an adhesive sheet in an environment where it comes into contact with an electrolyte.

The thermoplastic resin layers 120 may be made of a polyolefin resin to which a functional group has been added by surface treatment. Examples of the polyolefin resin include polyethylene, polypropylene, and ethylene-propylene copolymers. In this case, the thermoplastic resin layers 120 have excellent electrolyte-resistant adhesiveness and excellent initial adhesiveness. The “initial adhesiveness” as used herein means the adhesiveness immediately after the bonding and can also be said to be, in contrast to the “electrolyte-resistant adhesiveness”, the adhesiveness before coming into contact with an electrolyte.

The thermoplastic resin layers 120 preferably have a low Young's modulus, more specifically, a Young's modulus of 100 MPa or less. In this case, the thermoplastic resin layers 120 are less likely to peel off from the members 10 and 12.

The thermoplastic resin layers 120 preferably have low hygroscopicity. When the thermoplastic resin sheet 100 is heated during bonding or the like, water absorbed in the thermoplastic resin layers 120 may be vaporized by the heating and removed from the thermoplastic resin layers 120. Thereafter, a hole may remain in the thermoplastic resin layers 120, which may cause breakage of the thermoplastic resin layers 120 starting from the hole. Therefore, the lower the hygroscopicity of the thermoplastic resin layers 120, the more preferable it is.

The core material 110 has a lower linear thermal expansion coefficient than the thermoplastic resin. Accordingly, the linear thermal expansion coefficient of the thermoplastic resin sheet 100 as a whole is lower than when the thermoplastic resin sheet 100 does not include the core material 110, i.e., when the thermoplastic resin sheet 100 is constituted only by the thermoplastic resin layers 120. Therefore, even when the members 10 and 12 are metal, i.e., have low linear thermal expansion coefficients, the difference in linear thermal expansion coefficient between the thermoplastic resin sheet 100 and the members 10 and 12 is small, and the distortion of the thermoplastic resin sheet 100 can be suppressed. The core material 110 may be formed of a polyester resin having a low linear thermal expansion coefficient similar to that of metal, specifically polyethylene terephthalate (PET).

When the core material 110 is formed of a material having a melting point (e.g., resin, metal, or the like), the melting point of the core material 110 is preferably higher than that of the thermoplastic resin. Accordingly, when mounting the thermoplastic resin sheet 100, by heating the thermoplastic resin sheet 100 at a temperature higher than the melting point of the thermoplastic resin and lower than the melting point of the core material 110, the core material 110 does not melt, and hence, the shape thereof can be maintained. With the presence of the core material 110 of which the shape is maintained, spreading of each thermoplastic resin layer 120 in a surface direction when it melts can be suppressed.

When the core material 110 is formed of a material having no melting point (e.g., wood, paper, or the like), the heat resistance temperature of the core material 110 is preferably higher than that of the thermoplastic resin. The heat resistance temperature may be a temperature at which the shape of the core material 110 can be maintained. Accordingly, when mounting the thermoplastic resin sheet 100, by heating the thermoplastic resin sheet 100 at a temperature higher than the melting point of the thermoplastic resin and lower than the heat resistance temperature of the core material 110, the shape of the core material 110 can be maintained. With the presence of the core material 110 of which the shape is maintained, spreading of each thermoplastic resin layer 120 in a surface direction when it melts can be suppressed.

The core material 110 preferably has a structure that can be impregnated with the thermoplastic resin and, more specifically, has pores or minute irregularities at least on a surface. In this case, since the contact area between the core material 110 and each thermoplastic resin layer 120 is increased, the bonding force between the core material and the thermoplastic resin is improved. As a structure that can be impregnated with thermoplastic resin, the core material 110 may be a fiber structure formed of fiber. For example, the core material 110 may be a non-woven, woven, or knitted fiber structure. In this case, the core material 110 may be made of resin or metal. The core material 110 may also be made of wood, specifically paper.

The core material 110 may be a member that does not have pores or minute irregularities on a surface. In this case, the core material 110 may be a plate made of resin, metal, or the like.

The core material 110 preferably has electrolyte resistance. In this case, even when the core material 110 is exposed, the thermoplastic resin sheet 100 can be used in an environment where it comes into contact with an electrolyte.

The core material 110 preferably has excellent adhesion to the thermoplastic resin layers 120. In this case, the thermoplastic resin layers 120 are less likely to peel off from the core material 110.

The core material 110 preferably has low hygroscopicity and, for example, has lower hygroscopicity than the thermoplastic resin layers 120. The reason why lower hygroscopicity is preferred is the same as for the thermoplastic resin layers 120.

The above is the configuration of the thermoplastic resin sheet 100. In the following, a method for manufacturing the thermoplastic resin sheet 100 will be described.

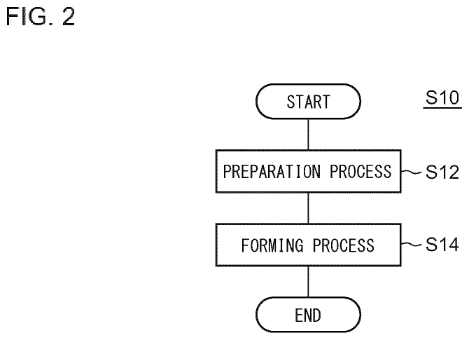

FIG. 2 is a process drawing that shows a manufacturing process S10 of the thermoplastic resin sheet 100. The manufacturing process S10 includes a preparation process S12 for preparing the core material 110 and thermoplastic resin, and a forming process S14 for forming the thermoplastic resin sheet 100 using the core material 110 and thermoplastic resin thus prepared.

For example, in the forming process S14, the core material 110 may be sandwiched between two sheets of thermoplastic resin and then heated and pressurized, so that the core material 110 is impregnated with the thermoplastic resin, and the two thermoplastic resin layers 120 sandwiching the core material 110 are formed.

Also, for example, in the forming process S14, the core material 110 may be conveyed in roll-to-roll processing and immersed in melted thermoplastic resin during the conveyance, so that the core material 110 is impregnated with the thermoplastic resin, and the two thermoplastic resin layers 120 sandwiching the core material 110 are formed.

Next, an example of application of the thermoplastic resin sheet 100 will be described.

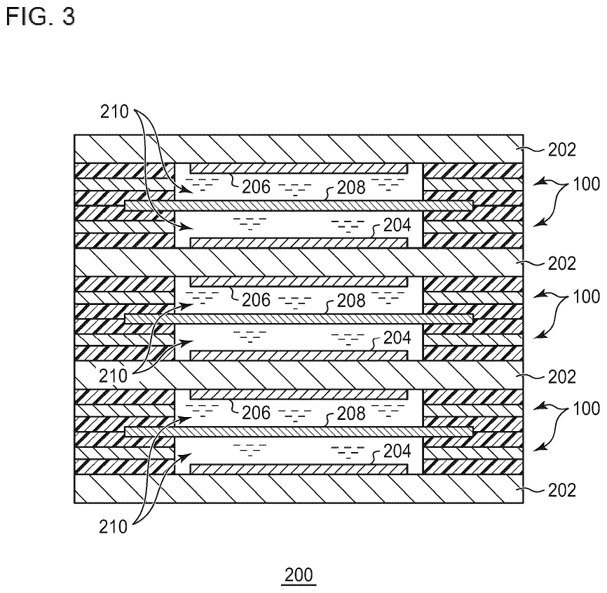

FIG. 3 shows a battery 200 that includes the thermoplastic resin sheet 100. The battery 200 is a bipolar battery. The battery 200 has a structure in which a positive electrode layer 204 and a negative electrode layer 206 are laminated on the respective surfaces of a current collector 202 of rectangular plate or sheet shape and a plurality of them are stacked. Between a positive electrode layer 204 and a negative electrode layer 206 facing each other, a separator 208 is provided. Adjacent current collectors 202 are joined, at a certain interval, by two thermoplastic resin sheets 100. The separator 208 is sandwiched, at its circumferential edge, between the two thermoplastic resin sheets 100 and hence held between the adjacent current collectors 202. The inside of the battery 200 is filled with an electrolyte 210 and sealed by the thermoplastic resin sheets 100. In other words, in the battery 200, each thermoplastic resin sheet 100 functions as an adhesive sheet and also as a sealing sheet.

The current collectors 202 are made of metal, such as aluminum, stainless steel, copper, or nickel, and have a low linear thermal expansion coefficient, more specifically, a very low linear thermal expansion coefficient of 1.0×10⁻⁴ or less. In contrast, each thermoplastic resin sheet 100 includes a core material 110, which has a lower linear thermal expansion coefficient than the thermoplastic resin layers 120; accordingly, the linear thermal expansion coefficient of a thermoplastic resin sheet 100 as a whole is lower than when the thermoplastic resin sheet 100 does not include the core material 110, i.e., it is close to the linear thermal expansion coefficient of the current collectors 202. Therefore, when the thermoplastic resin sheets 100 are heated for assembly of the battery 200, as described later, distortion of the thermoplastic resin layers 120 and thus the thermoplastic resin sheets 100 can be suppressed, so that higher adhesiveness or higher sealing properties can be achieved.

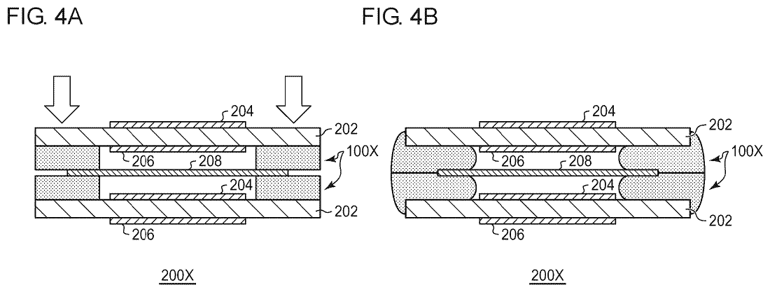

FIG. 4 shows a battery 200X that includes a thermoplastic resin sheet 100X according to a comparative example. The battery 200X is the same as the battery 200 except that each thermoplastic resin sheet 100X does not include a core material. FIG. 4A shows a state before the thermoplastic resin sheets 100X are mounted, and FIG. 4B shows a state after the thermoplastic resin sheets 100X are mounted, i.e., a state after the thermoplastic resin sheets 100X are pressurized while being heated to a temperature higher than or equal to the melting point of the thermoplastic resin. Since the thermoplastic resin sheets 100X according to the comparative example do not include core materials, the thermoplastic resin sheets 100X are likely to spread in a surface direction when heated and pressurized and can spread both inward and outward as shown in FIG. 4B. This would form the battery 200X with a thickness and external dimensions different from those designed. Also, there is a risk that a thermoplastic resin sheet 100X may come into contact with a positive electrode layer 204 or a negative electrode layer 206.

In contrast, in the battery 200 equipped with the thermoplastic resin sheets 100, since each thermoplastic resin sheet 100 includes a core material 110, spreading of the thermoplastic resin layers 120 in a surface direction can be suppressed, and the problems in the comparative example described above can be avoided.

Next, a method for manufacturing the battery 200 will be described.

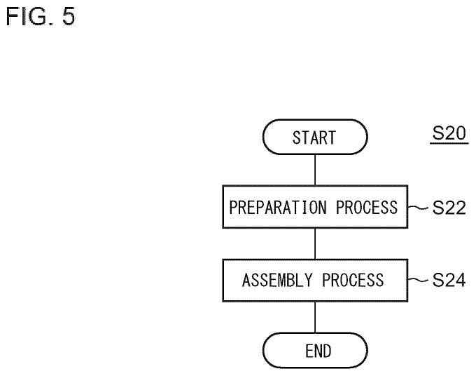

FIG. 5 is a process drawing that shows a manufacturing process S20 of the battery 200. The manufacturing process S20 includes a preparation process S22 for preparing the thermoplastic resin sheets 100, current collectors 202, positive electrode layers 204, negative electrode layers 206, separators 208, and electrolyte 210, and an assembly process S24 for assembling the components thus prepared.

In the assembly process S24, two thermoplastic resin sheets 100 together with the current collectors 202 adjacent thereto are sandwiched and pressurized using a predetermined jig, the thermoplastic resin sheets 100 are heated through the current collectors 202 using a predetermined heating device so that the thermoplastic resin layers 120 can be melted moderately, and the thermoplastic resin layers 120 are cooled to be solidified. The temperature at which the thermoplastic resin sheets 100 are heated is higher than the melting point of the thermoplastic resin layers 120 and lower than the melting point of the core materials 110. In this case, the core materials 110 do not melt, so that the shape of each core material 110 can be maintained.

The present disclosure has been described with reference to an embodiment. The embodiment is intended to be illustrative only, and it will be obvious to those skilled in the art that various modifications to a combination of constituting elements or processes in the embodiment could be developed and that such modifications also fall within the scope of the present disclosure. In the following, such modifications will be described.

### Modifications

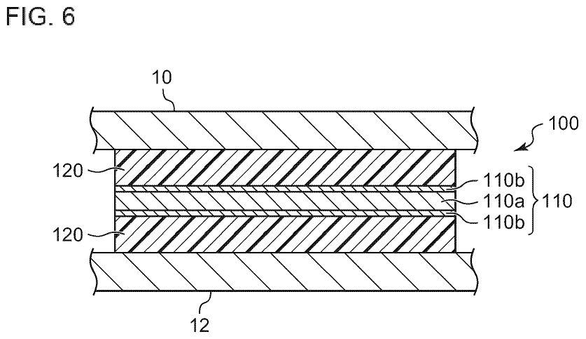

FIG. 6 is a sectional view of the thermoplastic resin sheet 100 according to a modification. FIG. 6 corresponds to FIG. 1. In this example, the core material 110 has a double structure. More specifically, the core material 110 includes an inner portion 110a, and outer portions 110b that sandwich the inner portion 110a.

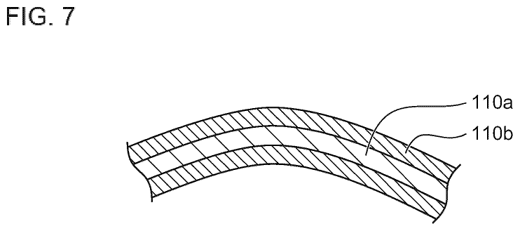

FIG. 7 is a sectional view of one of a number of fibers in the case where the core material 110 of the thermoplastic resin sheet 100 according to another modification is a fiber structure. In this example, each fiber has a double structure. More specifically, a fiber of the core material 110 includes an inner portion 110a of string shape located inside, and an outer portion 110b of hollow string shape surrounding the inner portion 110a.

In each of these core materials 110, at least the inner portion 110a has a lower linear thermal expansion coefficient than the thermoplastic resin layers 120.

The inner portion 110a preferably has a higher melting point than the thermoplastic resin layers 120. Each outer portion 110b has a lower melting point than the inner portion 110a. Each outer portion 110b may have a melting point equal to or lower than that of the thermoplastic resin layers 120. In this case, each outer portion 110b may be thinner than the inner portion 110a. When the thermoplastic resin sheet 100 is mounted between the first member 10 and the second member 12, the thermoplastic resin sheet 100 is heated at a temperature higher than the melting point of the thermoplastic resin layers 120 and the melting point of each outer portion 110b and lower than the melting point of the inner portion 110a. Accordingly, since the inner portion 110a does not melt, the shape of the core material 110 can be maintained. Meanwhile, each outer portion 110b melts together with the thermoplastic resin layers 120 and is therefore firmly bonded to the thermoplastic resin layers 120. Thus, the shape of the core material 110 can be maintained, and the core material 110 can be firmly bonded to the thermoplastic resin layers 120.

The inner portion 110a may be formed of polyester resin, such as PET. Each outer portion 110b may be formed of polyethylene, which has a lower melting point than polyester resin. Polyethylene is compatible with thermoplastic resin, enabling favorable heat sealing (impregnation) between each outer portion 110b and a thermoplastic resin layer 120.

When the embodiment and modifications set forth above are generalized, the following aspects are obtained.

### Aspect 1

A thermoplastic resin sheet as a sheet of thermoplastic resin, including
a core material of sheet shape that has a lower thermal expansion coefficient than the thermoplastic resin.

### Aspect 2

The thermoplastic resin sheet according to Aspect 1, wherein the melting point of the core material is higher than the melting point of the thermoplastic resin.

### Aspect 3

The thermoplastic resin sheet according to Aspect 1, wherein the heat resistance temperature of the core material is higher than the melting point of the thermoplastic resin.

### Aspect 4

The thermoplastic resin sheet according to any one of Aspects 1 through 3, wherein the core material is made of resin.

### Aspect 5

The thermoplastic resin sheet according to any one of Aspects 1 through 4, wherein the core material is a fiber structure.

### Aspect 6

The thermoplastic resin sheet according to any one of Aspects 1 through 5, wherein the core material is impregnated with thermoplastic resin.

### Aspect 7

The thermoplastic resin sheet according to any one of Aspects 1 through 6,
wherein the core material is a fiber structure of which each fiber has a double structure that includes an inner portion having a higher melting point than the thermoplastic resin, and an outer portion having a lower melting point than the inner portion, and
wherein the melting point of the outer portion is equal to or lower than the melting point of the thermoplastic resin.

### Aspect 8

A method for manufacturing a thermoplastic resin sheet as a method for manufacturing the thermoplastic resin sheet according to any one of Aspects 1 through 7, the method including
sandwiching the core material between sheets of the thermoplastic resin.

### Aspect 9

A method for manufacturing a thermoplastic resin sheet as a method for manufacturing the thermoplastic resin sheet according to according to any one of Aspects 1 through 7, the method including
impregnating the core material with the thermoplastic resin.

### Aspect 10

A method for manufacturing a battery, including:
preparing components including a current collector and the thermoplastic resin sheet according to any one of Aspects 1 through 7; and
assembling components thus prepared,
   the assembling including heating the thermoplastic resin sheet in a state of being sandwiched between current collectors.

### Aspect 11

The method for manufacturing a battery according to Aspect 10, wherein the heating includes heating to a temperature higher than the melting point of the thermoplastic resin and lower than the melting point of the core material.

What is claimed is:

1. A thermoplastic resin sheet as a sheet of thermoplastic resin, comprising
a core material of sheet shape that has a lower thermal expansion coefficient than the thermoplastic resin.

2. The thermoplastic resin sheet according to claim 1, wherein the melting point of the core material is higher than the melting point of the thermoplastic resin.

3. The thermoplastic resin sheet according to claim 1, wherein the heat resistance temperature of the core material is higher than the melting point of the thermoplastic resin.

4. The thermoplastic resin sheet according to claim 1, wherein the core material is made of resin.

5. The thermoplastic resin sheet according to claim 1, wherein the core material is a fiber structure.

6. The thermoplastic resin sheet according to claim 1, wherein the core material is impregnated with thermoplastic resin.

7. The thermoplastic resin sheet according to claim 1,
wherein the core material is a fiber structure of which each fiber has a double structure that includes an inner portion having a higher melting point than the thermoplastic resin, and an outer portion having a lower melting point than the inner portion, and
wherein the melting point of the outer portion is equal to or lower than the melting point of the thermoplastic resin.

8. A method for manufacturing a thermoplastic resin sheet as a method for manufacturing the thermoplastic resin sheet according to claim 1, the method comprising
sandwiching the core material between sheets of the thermoplastic resin.

9. A method for manufacturing a thermoplastic resin sheet as a method for manufacturing the thermoplastic resin sheet according to claim 1, the method comprising
impregnating the core material with the thermoplastic resin.

10. A method for manufacturing a battery, comprising:
preparing components including a current collector and the thermoplastic resin sheet according to claim 1; and
assembling components thus prepared,
the assembling comprising heating the thermoplastic resin sheet in a state of being sandwiched between current collectors.

11. The method for manufacturing a battery according to claim 10, wherein the heating includes heating to a temperature higher than the melting point of the thermoplastic resin and lower than the melting point of the core material.
